(19) United States
(12) Patent Application Publication
(10) Pub. No.: US 2017/0196032 A1
(43) Pub. Date: Jul. 6, 2017

(54) METHODS AND SYSTEMS FOR MANAGING A MOBILE DEVICE IN COMMUNICATION WITH A VEHICLE

(71) Applicant: LIVIO, INC., Royal Oak, MI (US)

(72) Inventors: Omar MAKKE, Lyon Township, MI (US); Oleg Yurievitch GUSIKHIN, Commerce Township, MI (US); David Allen KOWALSKI, Toledo, OH (US); Justin DICKOW, Royal Oak, MI (US); Joey Ray GROVER, Madison Heights, MI (US); Perry Robinson MACNEILLE, Lathrup Village, MI (US)

(21) Appl. No.: 15/398,237

(22) Filed: Jan. 4, 2017

Related U.S. Application Data
(60) Provisional application No. 62/275,088, filed on Jan. 5, 2016.

(51) Int. Cl. H04W 76/02; H04W 4/00; H04L 29/08

(52) U.S. Cl. CPC H04W 76/021; H04L 67/12; H04W 4/005; H04W 88/02

(57) ABSTRACT

A vehicle system includes a processor programed to output at a user interface a calibratable permission table based on input from a recognized system administrator. The calibratable permission table has one or more control parameters for controlling access to one or more infotainment settings via at least one occupant mobile device. The processor is further programed to, in response to the at least one occupant mobile device communicating with the processor, restrict the occupant mobile device based on the calibratable permission table.

### CROSS-REFERENCE TO RELATED APPLICATIONS

This application claims the benefit of U.S. provisional application Ser. No. 62/275,088 filed Jan. 5, 2016, the disclosure of which is hereby incorporated in its entirety by reference herein.

### TECHNICAL FIELD

The present disclosure generally relates to a management control strategy for an infotainment system that may receive user feedback from a mobile device to influence the content and the manner in which the infotainment system operates.

### BACKGROUND

A vehicle computing system is used to provide several features and functions including hands-free calling, navigation information and music to vehicle occupants while traveling to a destination. The vehicle computing system may provide settings to allow configuration of certain vehicle features and functions based on an occupant's preference. The settings may be configured once the occupant enters the vehicle. For example, the vehicle computing system may be configured to adjust music settings at the vehicle via a knob or button associated with infotainment settings. The music settings may be initiated using physically-actuated vehicle inputs manipulated by the vehicle occupant or by using the vehicle occupant's mobile device in communication with the vehicle computing system.

In some cases, an occupant may wish to perform a number of functions using an associated mobile device on an established communication link with the vehicle computing system. However, a driver of the vehicle may not want a non-driver vehicle occupant to access certain settings via a mobile device. For example, the driver may want to limit the configuration of certain vehicle features and functions from the non-driver's mobile device in communication with the vehicle computing system.

### SUMMARY

In at least one embodiment a vehicle system includes a processor programed to output at a user interface a calibratable permission table based on input from a recognized system administrator. The calibratable permission table has one or more control parameters for controlling access to one or more infotainment settings via at least one occupant mobile device. The processor is further programed to, in response to the at least one occupant mobile device communicating with the processor, restrict the occupant mobile device based on the calibratable permission table.

Embodiments may include a method using a vehicle processor to output a calibratable permission table based on a recognized system administrator. The calibratable permission table has one or more control parameters associated with control of at least one infotainment setting using an occupant mobile device. The method includes receiving, via a vehicle user interface display, input to set the one or more control parameters. The method further includes restricting the occupant mobile device from accessing the at least one infotainment setting based on the calibratable permission table.

Embodiments may also include, a computer-program product embodied in a non-transitory computer readable medium having stored instructions for programming a vehicle processor comprising instructions for recognizing, via the vehicle processor, an occupant mobile device as a driver or non-driver mobile device. The computer-program product includes further instructions for restricting the driver mobile device or non-driver mobile device based on a calibratable permission table having one or more control parameters associated with control of an infotainment setting using the occupant mobile device.

### BRIEF DESCRIPTION OF THE DRAWINGS

FIG. 1 is a representative topology of a vehicle computing system implementing a user-interactive vehicle information display system according to an embodiment;

FIG. 2 shows a block diagram illustrating the vehicle computing system providing a security check via a calibratable permission table for one or more mobile devices according to an embodiment;

FIGS. 3A and 3B show block diagrams of a vehicle user interface emulating the calibratable permission table according to an embodiment; and

FIG. 4 is a flow chart illustrating an example method of the vehicle computing system providing the security check for the one or more mobile devices communicating with the system according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (FLASH, random access memory (RAM), read only memory (ROM), electrically programmable read only memory (EPROM), electrically erasable programmable read only memory (EEPROM), or other suitable variants thereof, for example) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

The disclosure relates to a vehicle computing system and method configured to provide a security check via a calibratable permission table for managing control of vehicle functions using a mobile device. The vehicle functions may include, but are not limited to, climate controls, seat position controls, sunroof controls, music controls, and navigation system controls. The mobile device may adjust the vehicle functions via one or more remote control parameters via a remote control procedure call. A vehicle occupant, such as a driver and/or vehicle system administrator, may select a control option to restrict and/or limit the one or more remote control parameters using the calibratable permission table. The vehicle computing system may output the calibratable permission table via a vehicle user interface display.

In response to the system administrator's input to adjust a control parameter at the calibratable permission table, driver and/or non-driver mobile devices may be enabled to control a vehicle function based on the one or more remote control parameters. The driver and/or non-driver mobile devices may establish communication with the vehicle computing system, which can in turn allow permission to control various vehicle functions based on the calibratable permission table associated with the security check method and system.

In one example, the vehicle computing system (VCS) may execute the security check method to enable a system administrator to restrict a passenger mobile device from controlling the music control(s) based on an adjusted setting at the calibratable permission table. In another example, the system administrator may restrict a driver mobile device from controlling the navigation system control(s) based on an adjusted setting at the calibratable permission table. The security check method may have one or more software programs executed on hardware of the VCS, a passenger mobile device, and/or a combination thereof.

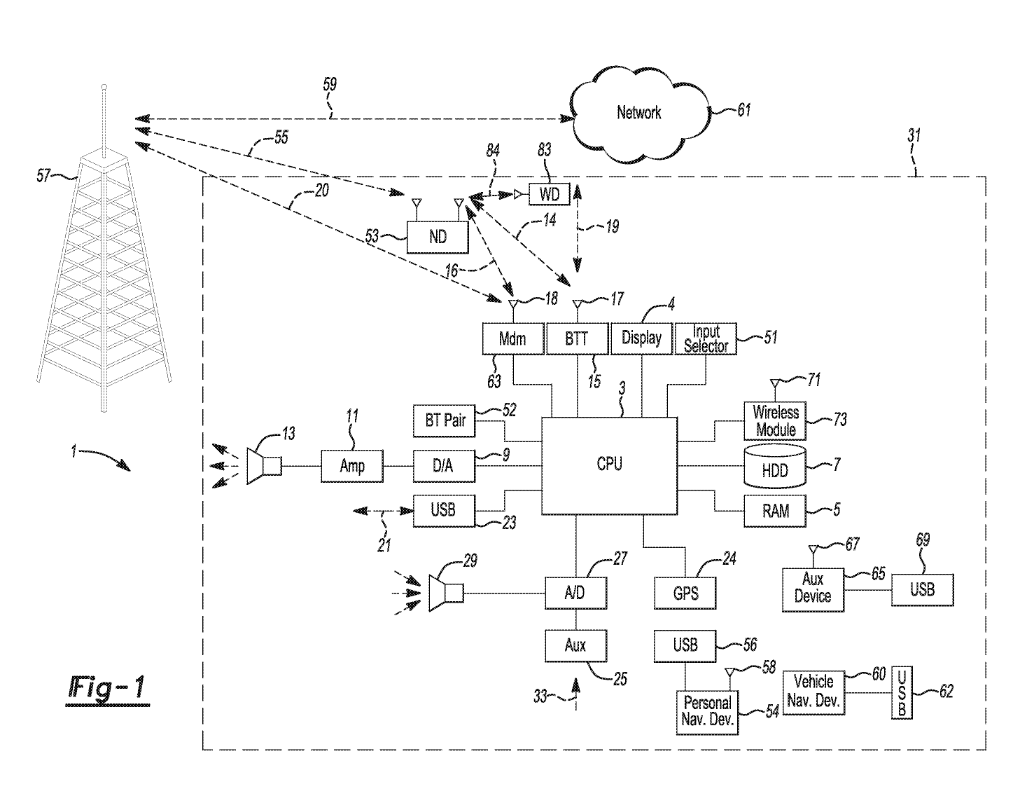

FIG. 1 illustrates an example block topology for the VCS 1 for a vehicle 31. An example of such a VCS 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, or a spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor 3 is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor 3 is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS 1 may use a vehicle network (such as, but not limited to, a CAN bus) to pass data to and from the VCS 1 (or components thereof).

In one example, the number of different inputs may be associated with a setting for one or more vehicle features and/or functions. In response to received input to adjust the setting associated with a vehicle feature and/or function, the processor 3 may communicate the adjusted setting to the vehicle feature via the vehicle network. For example, the processor 3 may receive a setting adjustment for a vehicle function from a connected mobile device. The processor 3 may transmit the received setting adjustment from the mobile device to a module executing the vehicle function via the vehicle network.

Outputs to the system may include, but are not limited to, a visual display 4 and a speaker 13 or stereo system output. The speaker 13 is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (cell phone, smartphone, tablet, PDA, or any other mobile device having wireless remote network connectivity, for example). The nomadic device 53 may then be used to communicate 59 with a network 61 outside the vehicle 31 through, for example, communication 55 with a cellular tower 57. In some embodiments, tower 57 may be a WiFi access point. The nomadic device 53 may also be used to communicate 84 with an accessory device such as a wearable device 83 (smartwatch, smart glasses, etc., for example). The nomadic device 53 may communicate one or more control functions to the wearable device 83. For example, the nomadic device 53 may enable the wearable device 83 to accept a phone call, enable a mobile application, receive notifications, and/or a combination thereof. In another example, the wearable device 83 may transmit vehicle control features/functions to the VCS 1 based on one or more mobile applications executed at the nomadic device 53.

Communication between the nomadic device 53 and the BLUETOOTH transceiver 15 is represented by signal 14. Pairing a nomadic device 53 and the BLUETOOTH transceiver 15 can be instructed through a button 52 or similar input. Accordingly, the CPU 3 is instructed so that the onboard BLUETOOTH transceiver 15 may be paired with a BLUETOOTH transceiver in a nomadic device 53. In another example, the wearable device 83 and the BLUETOOTH transceiver 15 is represented by signal 14. Comparable to the nomadic device BLUETOOTH pairing process, pairing a wearable device 83 and the BLUETOOTH transceiver 15 can be instructed through a button 52 or similar input. The onboard BLUETOOTH transceiver 15 may be paired with a BLUETOOTH transceiver in a wearable device 83.

The processor 3 may be configured to communicate information to a previously paired nomadic and/or wearable device 53, 83 (a mobile device, for example). The processor 3 may be configured to request communication with a previously paired mobile device. For example, in response to the requested communication from the processor 3, the previously paired mobile device 53 may transmit an established communication message to the processor 3.

In one example, the mobile device 53 may execute one or more applications via a mobile device processor. The mobile device 53 may communicate data associated with the one or more applications to the VCS 1. The one or more applications may include an application associated with controlling one or more vehicle functions via the mobile device 53. The mobile device 53 may be configured to control the one or more vehicle functions associated with the vehicle features via an established communication link with the VCS 1. For example, the mobile device 53 may adjust a destination input for a vehicle navigation system at the VCS 1. In another example, the mobile device 53 may adjust settings of a sunroof actuator to control an open and close position of a sunroof.

Data may be communicated between CPU 3 and network 61 utilizing, for example, a data-plan, data over voice, or DTMF tones associated with a mobile device 53. Alternatively, it may be desirable to include an onboard modem 63 having an antenna 18 in order to communicate 16 data between CPU 3 and network 61 over the voice band. The mobile device 53 may then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor 3 is provided with an operating system including an application program interface (API) to communicate with modem application software. The modem application software may access an embedded module or firmware on the BLUETOOTH transceiver to complete wireless communication with a remote BLUETOOTH transceiver (such as that found in a mobile device 53). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the mobile device 53 includes a modem for voice band or broadband data communication. In the data-over-voice embodiment, a technique known as frequency division multiplexing may be implemented when the owner of the mobile device 53 can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the mobile device 53, it is possible that the data-plan allows for broad-band transmission and the system could use a much wider bandwidth (speeding up data transfer). In still another embodiment, mobile device 53 is replaced with a cellular communication device (not shown) that is installed to vehicle 31. In yet another embodiment, the mobile device 53 may be a wireless local area network (LAN) device capable of communication over, for example (and without limitation), an 802.11g network (i.e., WiFi) or a WiMax network.

In one embodiment, incoming data can be passed through the mobile device 53 via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. The additional sources may be configured to control one or more vehicle functions at the vehicle computing system 1. In another example, the mobile device (nomadic device 53, wearable device 83, etc., for example) may communicate with the processor via USB connection. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU 3 could be in communication with a variety of other auxiliary devices 65. These devices can be connected through a wireless 67 or wired 69 connections. Auxiliary device 65 may include, but are not limited to, personal media players, wireless health devices, portable computers, and the like. The auxiliary device 65 may communicate one or more setting adjustments to control a vehicle function at the vehicle computing system 1.

Also, or alternatively, the CPU 3 could be connected to a vehicle based wireless router 73, using for example a WiFi (IEEE 803.11) 71 transceiver. This could allow the CPU 3 to connect to remote networks in range of the local router 73.

In addition to having representative processes executed by a VCS 1 located in a vehicle, in certain embodiments, the processes may be executed by a computing system in communication with a vehicle computing system. Such a system may include, but is not limited to, a mobile device (a tablet, a smartphone, the nomadic device 53, wearable device 83 etc., for example) or a remote computing system (a server 61, for example) connected through the mobile device 53. Collectively, such systems may be referred to as vehicle associated computing systems (VACS). In certain embodiments particular components of the VACS may perform particular portions of a process depending on the particular implementation of the system. By way of example and not limitation, if a process includes sending or receiving information with a paired mobile device, then it is likely that the mobile device is not performing the process, since the mobile device would not “send and receive” information with itself. One of ordinary skill in the art will understand when it is inappropriate to apply a particular VACS to a given solution. In all solutions, it is contemplated that at least the vehicle computing system (VCS) 1 located within the vehicle itself is capable of performing the processes.

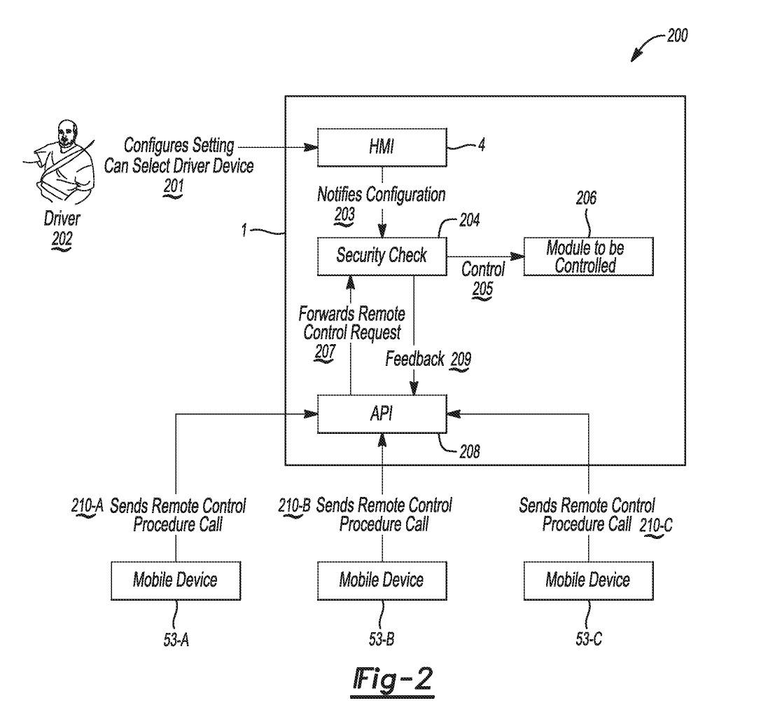

FIG. 2 shows a block diagram 200 illustrating the VCS 1 providing a security check via a calibratable permission table for one or more mobile devices in communication with the system according to an embodiment. The CPU 3 may be in communication with one or more transceivers. The one or more transceivers are capable of wired and wireless communication for the integration of one or more mobile devices. To facilitate the integration, the CPU 3 may include a device integration framework (an application program interface, for example) configured to provide various vehicle features and functions to the connected mobile devices. These services may include transport routing of messages between the connected devices and the CPU 3, global notification services to allow connected devices to provide alerts to the user, an application to allow for control of vehicle functions executed by the CPU 3 and those executed by the connected devices, accident detection notification (911 ASSIST™, that is), vehicle access control (locking and unlocking the vehicle doors, for example), and point of interest location and management services for various possible vehicle 31 destinations.

As described above, the CPU 3 of the VCS 1 may be configured to interface with one or more mobile devices 53 of various types. The VCS 1 may provide the security check to monitor the one or more mobile devices 53 communicating with one or more vehicle functions. The mobile device 53 may further include a device integration client component to allow the mobile device 53 (smartphone, for example) to take advantage of the services provided by the device integration framework. The device integration client component may be referred to as an application. The application is executed on hardware of the mobile device 53. The application may communicate data from the mobile device 53 to the VCS 1 via the transceiver. In one example, the application may enable a user of the mobile device to control one or more vehicle functions via a mobile device user interface display.

The one or more transceivers may include a multiport connector hub. The multiport connector hub may be used to interface between the VCS 1 and additional types of connected devices other than the mobile devices 53. The multiport connector hub may communicate with the CPU 3 over various buses and protocols, such as via USB, and may further communicate with the connected devices using various other connection buses and protocols, such as Serial Peripheral Interface Bus (SPI), Inter-integrated circuit (I2C), and/or Universal Asynchronous Receiver/Transmitter (UART). The multiport connector hub may further perform communication protocol translation and interworking services between the protocols used by the connected devices and the protocol used between the multiport connector hub and the CPU 3. The connected devices may include, as some non-limiting examples, a radar detector, a global position receiver device, and a storage device. The security check executed at the VCS 1 may provide one or more settings via the calibratable permission table to manage control of vehicle functions via the additional types of connected devices.

The VCS 1 may allow a driver, vehicle occupant, and/or system administrator 202 to request configuration of one or more settings associated with vehicle features or functions. The one or more settings may include the calibratable permission table for managing control of a vehicle feature or function via the mobile device 53. The VCS 1 may output the one or more settings associated with the vehicle features or functions at the vehicle user interface display 4. For example, the driver 202 may request to configure settings 201 associated with the calibratable permission table via the vehicle human machine interface (HMI) 4. The VCS may require at least one of an alphanumeric PIN, a predefined key, and a previously identified mobile device before outputting the calibratable permission table.

For example, the HMI 4 may output the calibratable permission table based on a recognized mobile device communicating with the VCS 1, a recognized system administrator input, a recognized key, and/or a combination thereof. The driver may select the calibratable permission table associated with managing control of vehicle functions using one or more connected mobile devices. The VCS 1 may request an alphanumeric PIN before outputting the calibratable permission table to the HMI 4. In another example, in response to the selection for the calibratable permission table, the VCS 1 may output the calibratable permission table if a previously identified mobile device is recognized by the system.

In response to an authorized alphanumeric PIN verified by the VCS 1, the system may output the calibratable permission table at the HMI 4. The calibratable permission table may include one or more control parameters for controlling access to one or more infotainment settings via at least one occupant mobile device communicating with the VCS 1. For example, the calibratable permission table may include one or more options to enable a mobile device to control a vehicle function. The one or more options may include allowing all mobile devices communicating with the VCS to remotely control a vehicle feature and/or function. In another example, the one or more options may restrict remote control of a vehicle feature and/or function via a recognized driver and/or passenger device as illustrated in Table 1 below:

TABLE 1
Permission Table For Vehicle Actuators
(Seat, Sunroof, Window Control)

| | |
|---|---|
| Option 1 | All Remote Control Allowed |
| Option 2 | Allow Driver Only Remote Control/Not Passenger |
| Option 3 | Prevent all Remote Control |
| Option 4 | Allow Passenger Only Remote Control/Not Driver |

As shown in the representative calibratable permission table illustrated above in Table 1, the driver and/or system administrator 202 may select an option to manage control of a vehicle actuator via a mobile device. The vehicle actuator may include, but is not limited to seat controls, sunroof controls, and window controls. The VCS 1 may recognize the mobile device as a driver or passenger device. In response to a recognized mobile device as a driver or passenger mobile device, the VCS 1 may allow or restrict control of the actuator based on the selected option in Table 1. Variations on the permissions illustrated in the Table 1 are possible. While many examples herein discuss driver and passenger permissions, in other cases the permissions may be based on seating position of the user, such that different permissions may be specified for different passenger seating positions. For instance, different permissions may be specified for front row passengers, second row passengers, third row passengers. Or, different permissions may be specified for a driver seating position, a front row passenger seating position, a second row driver side seating position, a second row passenger side seating position, etc.

The VCS 1 may receive the selected setting option 201 via the HMI 4. The VCS 1 may transmit 203 the configuration of the selected setting option 201 via the calibratable permission table to a mobile device security check application 204 being executed on hardware of the VCS 1. In another example, the security check application 204 may be executed at the VCS 1, the connected mobile device 53, and the remote server in communication with the system.

The security check application 204 may manage control 205 of the one or more vehicle functions at a vehicle module 206 based on the calibratable permission table. For example, the security check 204 may restrict a passenger mobile device control 205 of a vehicle function at a module 206 executing the vehicle function. Continuing from the example, the module 206 may control music selections for output at the speakers. The calibratable permission table may restrict a recognized passenger mobile device from controlling a music selection based on the security check application 204.

The security check 204 may communicate with an application program interface (API) that is configured to establish a communication protocol with one or more mobile devices 53. For example, the API may receive one or more messages from the connected mobile devices 53. The API may forward 207 a remote control request from a connected mobile device 53 to the security check application 204. In response to the calibratable permission table settings, the security check 204 may either enable control or restrict control for the remote control request received from the mobile device 53. If the calibratable permission table enables control from a mobile device 53, the security check 204 may transmit a control request 205 to the module to be controlled 206 via the mobile device 53. The security check 204 may provide feedback 209 to the mobile device 53 based on the security check application 204 via the API 208.

The VCS 1 may establish communication with one or more mobile devices 53-A through 53-C via the API 208. In one example, a driver mobile device 53-A may be recognized by the VCS 1. The VCS 1 may receive a remote control procedure call 210-A from the recognized driver mobile device 53-A via the API 208. The VCS 1 may determine if the remote control procedure call 210-A is enabled or restricted based on the security check application 204. In response to the calibratable permission table having an option selected to enable a recognized driver device to control a vehicle function, the VCS 1 may transmit the control procedure call via the security check application 204 to the associated module 206 executing the vehicle function.

In another example, one or more passenger mobile devices 53-B, 53-C may be recognized by the VCS 1. More specifically, the VCS 1 may recognize a front seat passenger mobile device 53-B and a backseat passenger mobile device 53-C. In response to a recognized front seat passenger mobile device 53-B, the security check 204 may receive a remote control procedure call 210-B via the API 208. The VCS 1 may enable or restrict the remote control procedure call 210-B based on the calibratable permission table. For example, the front seat passenger mobile device may transmit a remote control procedure call to adjust a climate control. The climate control may include, but is not limited to, fan speed control, temperature adjustment control, heated seat control, and air-conditioned seat control. The VCS 1 may control a vehicle climate control system via the climate control adjustment received from the front seat passenger mobile device 53-B based on the calibratable permission table.

Continuing from the example above, the VCS 1 may recognize a backseat passenger mobile device 53-C. The backseat passenger mobile device 53-C may transmit 210-C a control procedure call to the VCS 1 via the API 208. More specifically, the security check application 204 may receive 207 the remote control request from the backseat passenger mobile device 53-C via the API 208. The security check application 204 may provide feedback to the mobile device 53-C for notifying the backseat passenger if the control procedure call 210-C has been enabled or restricted based on the calibratable permission table.

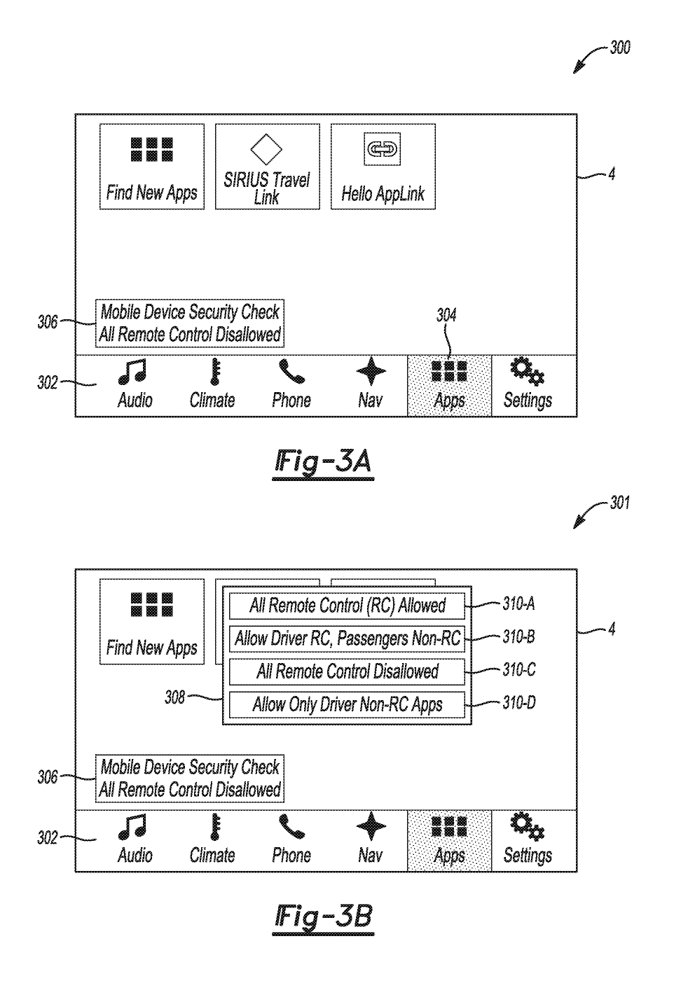

FIGS. 3A and 3B show block diagrams of a vehicle user interface 4 emulating the calibratable permission table according to an embodiment. The user interface 300 in FIG. 3A may be presented at the touchscreen display 4 and may include a vehicle function banner 302. The vehicle function banner 302 may include, but is not limited to, audio controls (music controls, for example), climate controls, phone controls, navigation controls, applications 304, and other infotainment settings. The applications may be outputted at the touchscreen display 4. The applications may include the mobile device security check application 306. The security check application 306 may provide a current restriction status at the display 4. For example, the mobile device security check application may output the current setting selected is all remote control disallowed from one or more connected mobile devices.

In response to a system administrator and/or driver selecting the security check application 306, the user interface 301 in FIG. 3B illustrates an output of the calibratable permission table 308 having selectable list entries 310-A through 310-D (collectively 310). The selectable list entries 310 provide management setting options associated with connected mobile devices requesting control of the one or more vehicle functions.

In response to a selected setting option via the selectable list entries 310 at the display 4, the VCS 1 may enable or restrict a driver and/or passenger mobile device 53 from controlling a vehicle function. The VCS 1 may highlight each of the one or more selectable list entries 310 that may be configured based on the driver and/or system administrator selection.

As illustrated in FIG. 3B, the selectable list 310 of the calibratable permission table 308 includes an entry 310-A for enabling all remote control for all connected mobile devices, an entry 310-B for enabling control of a vehicle function associated with a feature from only a driver mobile device, an entry 310-C for restricting control of the vehicle function from all connected mobile devices, and an entry 310-D for enabling only a passenger mobile device to control the vehicle function. The calibratable permission table 308 may operate as a menu, such that an occupant may scroll through the list entries of the table (using up and down arrow buttons and a select button to invoke the selected menu item, for example).

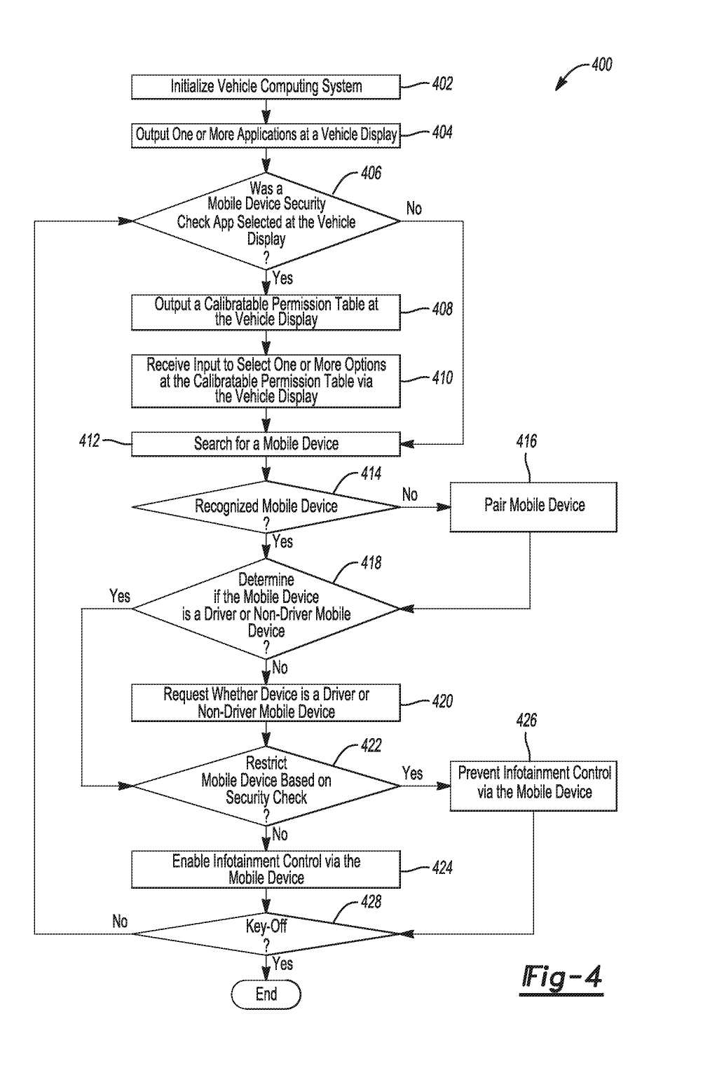

FIG. 4 is a flow chart illustrating operation of an example system or method of the VCS 1 providing the mobile device security check for the one or more mobile devices communicating with the system according to an embodiment. The system or method 400 may include instructions for providing a calibratable security check method and restricting one or more mobile devices based on the calibratable permission table. The method 400 may be implemented using software code contained within the VCS 1. In other embodiments, the method 400 may be implemented in other vehicle controllers (one or more modules, for example), or distributed among multiple vehicle modules.

Referring again to FIG. 4, the vehicle and its components illustrated in FIG. 1 FIG. 2, FIG. 3A and FIG. 3B are referenced throughout the discussion of the method 400 to facilitate understanding of various aspects of the present disclosure. The method 400 of managing a remote control request for a vehicle function from a connected mobile device 53 may be implemented through a computer algorithm, machine executable code, or software instructions programmed into a suitable programmable logic device(s) of the vehicle, such as the processor 3, the mobile device processor, another controller in communication with the vehicle computing system, or a combination thereof. Although the various operations shown in the flowchart diagram 400 appear to occur in a chronological sequence, at least some of the operations may occur in a different order, and some operations may be performed concurrently or not at all.

In operation 402, the VCS 1 may be initialized and enabled based on a key-on position or state of an ignition system. The VCS 1 may initialize one or more applications for execution. In response to the initialization of the VCS 1, the system may display one or more applications at a user interface display. For example, the VCS 1 may execute the mobile device security check application configured to manage a remote control of a vehicle function from a mobile device 53 connected to the system via a communication link (USB, BLUETOOTH, etc., for example). The VCS 1 may communicate application data between the mobile device 53 and the applications being executed on hardware at the system.

The VCS 1 may output one or more application options at the vehicle display in operation 404. The one or more application options may include, but are not limited to, the security check application. The VCS 1 may determine if the security check application was selected at the vehicle user interface display in operation 406.

In response to the security check application being requested for configuration, the VCS 1 may output a calibratable permission table at the vehicle user interface display in operation 408. The VCS 1 may receive input to select one or more security options associated with the calibratable permission table via the vehicle user interface display in operation 410.

For example, the calibratable permission table may have one or more options that include, but are not limited to, restricting a non-driver mobile device from control access to one or more infotainment settings based on the at least one occupant mobile device being the non-driver mobile device communicating with the VCS 1, restricting the driver mobile device from control access to one or more infotainment settings based on the at least one occupant mobile device being the driver mobile device communicating with the VCS 1, or restricting the driver and non-driver mobile devices from control access to one or more infotainment settings based on the at least one occupant mobile device being the driver and non-driver mobile devices communicating with the VCS 1. The one or more infotainment settings are vehicle functions that can be controlled via the VCS 1, such as climate controls, seat position controls, music controls, navigation controls, and sunroof controls.

The VCS 1 may search for the mobile device 53 based on the initialization of the system in operation 412. In response to a detected mobile device within a vehicle cabin, the VCS 1 may determine if the device is recognized as a previously paired device while estimating a location for the device within the vehicle cabin in operation 414. If the VCS 1 detects an unrecognized mobile device 53, the system may perform a pairing process with the mobile device in operation 416. The VCS 1 may determine if the mobile device 53 is a driver or non-driver mobile device in operation 418.

In response to the VCS 1 not being able to detect whether the detected mobile device 53 is a driver or non-driver mobile device, the VCS 1 may request occupant input via the user interface display to identify the mobile device 53 as a driver or non-driver mobile device in operation 420. The VCS 1 may determine whether or not to restrict the mobile device control calls for one or more vehicle functions based on the calibratable permission table associated with the security check application in operation 422.

In response to the recognized mobile device having at least one restriction identified in the calibratable permission table, the VCS 1 may prevent infotainment control via the recognized mobile device in operation 426. In response to the recognized mobile device having no restrictions identified in the calibratable permission table, the VCS 1 may enable infotainment control via the recognized mobile device in operation 424. The VCS 1 may end the method of managing a vehicle function control request via the mobile device 53 based on a detection of a key-off position of the ignition system in operation 428.

While representative embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle system comprising:
a calibratable permission table having one or more control parameters for controlling access to one or more infotainment settings via at least one occupant mobile device; and
a processor, programed to
in response to a recognized system administrator input, output the calibratable permission table at a user interface, and
in response to the at least one occupant mobile device communicating with the processor, restrict the occupant mobile device based on the calibratable permission table.

2. The system of claim 1, wherein the processor is further programed to recognize a driver mobile device based on the at least one occupant mobile device communicating with the processor.

3. The system of claim 2, wherein the processor is further programed to restrict the driver mobile device based on the calibratable permission table.

4. The system of claim 2, wherein the one or more control parameters for the calibratable permission table restricts a non-driver mobile device from control access to one or more infotainment settings based on the at least one occupant mobile device being the non-driver mobile device communicating with the processor, restricts the driver mobile device from control access to one or more infotainment settings based on the at least one occupant mobile device being the driver mobile device communicating with the processor, or restricts the driver and non-driver mobile devices from control access to one or more infotainment settings based on the at least one occupant mobile device being the driver and non-driver mobile devices communicating with the processor.

5. The system of claim 1, wherein the one or more infotainment settings are at least one of climate controls, seat position controls, music controls, navigation controls and sunroof controls.

6. The system of claim 5, wherein the one or more control parameters for the climate controls is at least one of fan speed control, temperature adjustment control, heated seat control, and air-conditioned seat control.

7. The system of claim 1, wherein the processor is programed to, in response to the one or more control parameters restricting control from a non-driver mobile device, control the one or more infotainment settings via the at least one occupant mobile device being a driver mobile device.

8. The system of claim 1, wherein the processor is further programed to recognize the system administrator input based on at least one of an alphanumeric PIN, a predefined key, and a previously identified mobile device.

9. The system of claim 1, wherein the processor is further programed to, in response to the at least one occupant mobile device having a restriction based on the calibratable permission table, transmit a lock-out feature to the at least one occupant mobile device.

10. A method comprising:
in response to a recognized system administrator input, outputting, via a vehicle processor, a calibratable permission table having one or more control parameters associated with control of at least one infotainment setting using an occupant mobile device;
receiving, via a vehicle user interface display, input to set the one or more control parameters; and
restricting the occupant mobile device from accessing the at least one infotainment setting based on the calibratable permission table.

11. The method of claim 10, further comprising recognizing a driver mobile device based on the occupant mobile device communicating with the vehicle processor.

12. The method of claim 11, further comprising restricting the driver mobile device based on the calibratable permission table.

13. The method of claim 11, wherein the one or more control parameters for the calibratable permission table restricts a non-driver mobile device from control access to one or more infotainment settings, restricts the driver mobile device from control access to one or more infotainment settings, or restricts the driver and non-driver mobile devices from control access to one or more infotainment settings.

14. The method of claim 10, further comprising recognizing the system administrator input based on at least one of an alphanumeric PIN, a predefined key, and a previously identified mobile device.

15. The method of claim 10, wherein the at least one infotainment setting includes at least one of a climate control setting, a seat position control setting, a music control setting, a navigation control setting and a sunroof control setting.

16. The method of claim 15, wherein the one or more control parameters for the music controls include at least one of volume adjustment control, sound setting control, or radio control.

17. A computer-program product embodied in a non-transitory computer readable medium having stored instructions for programming a vehicle processor, comprising instructions for:
recognizing, via a vehicle processor, an occupant mobile device as a driver or non-driver mobile device; and
restricting the driver or non-driver mobile device based on a calibratable permission table having one or more control parameters associated with control of an infotainment setting using the occupant mobile device.

18. The computer-program product of claim 17, wherein the non-transitory computer readable medium further comprises instructions for, in response to a recognized system administrator, outputting the calibratable permission table to a vehicle user interface display.

19. The computer-program product of claim 17, wherein the one or more control parameters for the calibratable permission table restricts a non-driver mobile device from control access to one or more infotainment settings based on the at least one occupant mobile device being the non-driver mobile device communicating with the processor, restricts the driver mobile device from control access to one or more infotainment settings based on the at least one occupant mobile device being the driver mobile device communicating with the processor, or restricts the driver and non-driver mobile devices from control access to one or more infotainment settings based on the at least one occupant mobile device being the driver and non-driver mobile devices communicating with the processor.

20. The computer-program product of claim of claim 17, wherein the infotainment setting is navigation controls such as an entered destination input or selected point of interest.
